(19) United States
(12) Patent Application Publication
(10) Pub. No.: US 2010/0164381 A1
(43) Pub. Date: Jul. 1, 2010

(54) LONG LINEAR-TYPE MICROWAVE PLASMA SOURCE USING VARIABLY-REDUCED-HEIGHT RECTANGULAR WAVEGUIDE AS PLASMA REACTOR

(75) Inventors: CHIH-CHEN CHANG, Taipei County (TW); TUNG-CHUAN WU, Hsinchu City (TW); CHAN-HSING LO, Hsinchu County (TW); CHING-HUEI WU, Hsinchu City (TW); MUH-WANG LIANG, Miaoli County (TW); FU-CHING TUNG, Hsinchu City (TW); SHIH-CHIN LIN, Hualien County (TW); JEN-RONG HUANG, Hsinchu City (TW)

Correspondence Address: WPAT, PC;INTELLECTUAL PROPERTY ATTORNEYS, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/470,776

(22) Filed: May 22, 2009

(30) Foreign Application Priority Data
Dec. 25, 2008 (TW) 097150614

(51) Int. Cl. H05H 1/46

(52) U.S. Cl. 315/39; 315/111.21

(57) ABSTRACT

A long linear-type microwave plasma source using a variably-reduced-height rectangular waveguide as the plasma reactor has been developed. Microwave power is fed from the both sides of the waveguide and is coupled into plasma through a long slot cut on the broad side of the waveguide. The reduced height of the waveguide is variable in order to control the coupling between microwave and plasma so that the plasma uniformity can remain a high quality when extending the length of the linear-type plasma source.

### FIELD OF THE INVENTION

The present invention generally relates to a microwave plasma source and, more particularly, to a microwave plasma source using a variably-reduced-height waveguide as a linear-type plasma reactor.

### BACKGROUND OF THE INVENTION

As the throughput of silicon-based solar cells increases, continuous plasma enhanced chemical vapor deposition that is widely used in the making of anti-reflecting layers has to be significantly changed. In other words, the employed plasma source has to be extended linearly along the direction perpendicular to the conveyor belt to achieve enhanced throughput.

FIG. 1A and FIG. 1B are side views of a conventional long linear-type microwave plasma source from different viewing angles. The long linear-type microwave plasma source 100 is disclosed in Germany Patent DE19812558A1. In FIG. 1A and FIG. 1B, the long linear-type microwave plasma source 100 comprises a reaction chamber 110, a quartz tube 120 and a cylindrical waveguide 130. The cylindrical waveguide 130 is disposed inside the quartz tube 120. The quartz tube 120 is disposed inside the reaction chamber 110.

Therefore, when microwave 50 is applied to the cylindrical waveguide 130, the microwave 50 travels inside the cylindrical waveguide 130 and then leaks out of the surface of the cylindrical waveguide 130 to pass through the quartz tube 120 to excite plasma 60. The plasma 60 reaches the surface of the silicon substrate 140 to form a thin film.

FIG. 1C shows the plasma density profiles of a long linear-type microwave plasma source in FIG. 1B, wherein the longitudinal axis denotes the plasma density and the traversal axis denotes the position. Referring to FIG. 1B and FIG. 1C, the plasma density n₁ is distributed from the plasma generated due to the microwave power 50′ applied on the left and decreases along the traversal axis. On the contrary, the plasma density n₂ is distributed from the plasma generated due to the microwave power 50″ applied on the right and increases along the traversal axis. Therefore, the actual plasma density n in the reaction chamber 110 is the sum of the plasma density n₁ and the plasma density n₂.

However, to achieve enhanced throughput, the size of the long linear-type microwave plasma source 100 has to be enlarged to improve the rate of thin film deposition. As a result, both the microwave power 50′ applied from the left and the microwave power 50″ applied from the right may leak and decline so that the actual excited plasma distribution is as shown in FIG. 1D, wherein the plasma density n as a sum of the plasma density n₁ and the plasma density n₂ is not uniform. More particularly, the plasma density is higher on both ends and lower at the center.

Even though the aforesaid problem can be overcome by increasing the input microwave power, the increased cost is proportional to orders of the increased microwave power. Therefore, the high-power microwave generator is very costly, which makes the plasma processing less competent due to high cost.

Referring to FIG. 1A, and FIG. 1B, however, the quartz tube 120 is surrounded by the plasma 60, which causes deposition on the quartz tube 120 and even etching on the quartz tube 120. This results in poor efficiency and poor uniformity of plasma intensity of the plasma 60 excited by the microwave power so that the film quality on the silicon substrate 140 is degraded.

Therefore, the quartz tube 120 has to be renewed periodically to enhance the efficiency of plasma 60 excited by the microwave 50. However, the replacement of the quartz tube 120 is not very easy, which causes lower throughput of the long linear-type microwave plasma source 100. This increases the manufacturing cost of the solar cells.

### SUMMARY OF THE INVENTION

In view of the above, the present invention provides a long linear-type microwave plasma source using a variably-reduced-height waveguide so as to adjust microwave leakage and achieve enhanced throughput by generating long linear-type uniform plasma.

Moreover, the present invention provides a long linear-type microwave plasma source, comprising a reaction chamber, a variably-reduced-height waveguide, a long linear-type coupling window and a moving mechanism. The variably-reduced-height waveguide is disposed on the reaction chamber and comprises a frame portion, a long linear-type coupling frame, a first moving portion and two second moving portions. The frame portion has a first wide side adjacent to the reaction chamber. The long linear-type coupling frame is disposed on the first wide side of the frame portion. The first moving portion and the two second moving portions are disposed inside the frame portion, wherein the first moving portion is disposed between the second moving portions. The long linear-type coupling window is disposed on a linear slot. The moving mechanism is capable of adjusting the distance between the first moving portion and the first wide side and the distance between the second moving portions and the first wide side.

In the long linear-type microwave plasma source of the present invention, the distance between the first moving portion and the first wide side is adjusted to control the input microwave leakage so that the waveguide power input at one end vanishes before it reaches the other end. As a result, the standing wave ratio (SWR) is reduced and the microwave power efficiency is enhanced to maintain the plasma uniformity.

### BRIEF DESCRIPTION OF THE DRAWINGS

The objects and spirits of the embodiments of the present invention will be readily understood by the accompanying drawings and detailed descriptions, wherein:

FIG. 1A and FIG. 1B are side views of a conventional long linear-type microwave plasma source from different viewing angles;

FIG. 1C shows the plasma density profiles of a long linear-type microwave plasma source in FIG. 1B;

FIG. 2A is a cross-sectional view of a long linear-type microwave plasma source according to one embodiment of the present invention;

FIG. 2B is a cross-sectional view of the long linear-type microwave plasma source in FIG. 2A; and

FIG. 2C is a 3D exploded view of the long linear-type microwave plasma source in FIG. 2A.

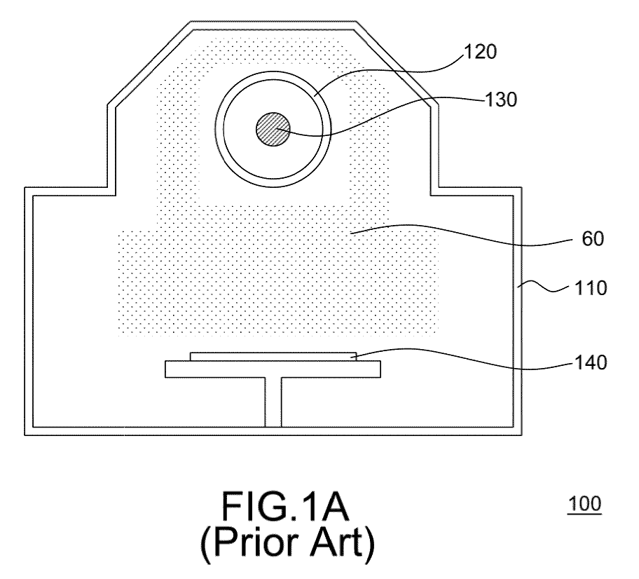

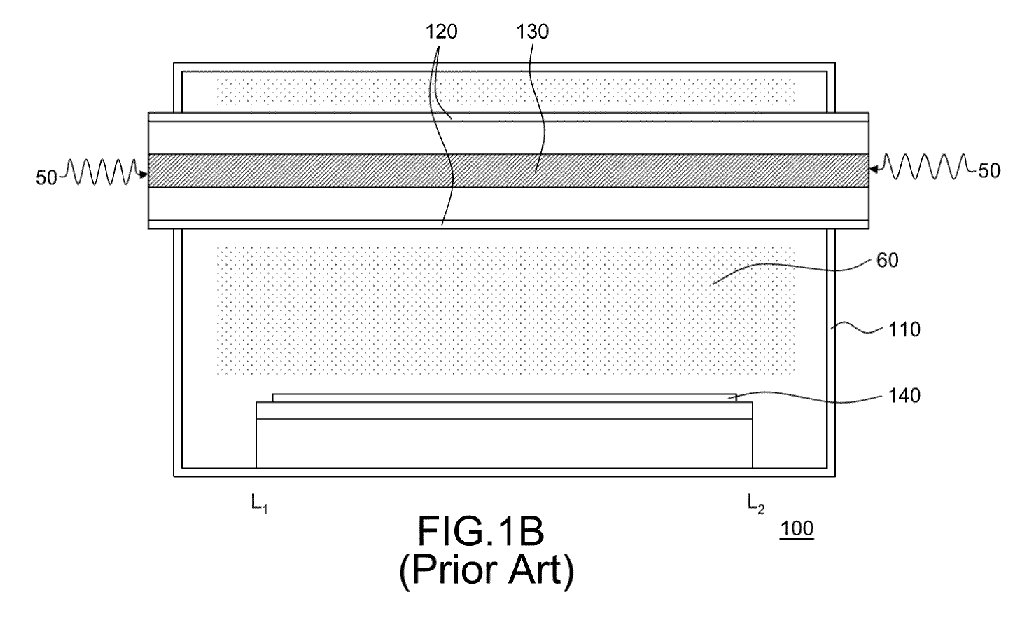

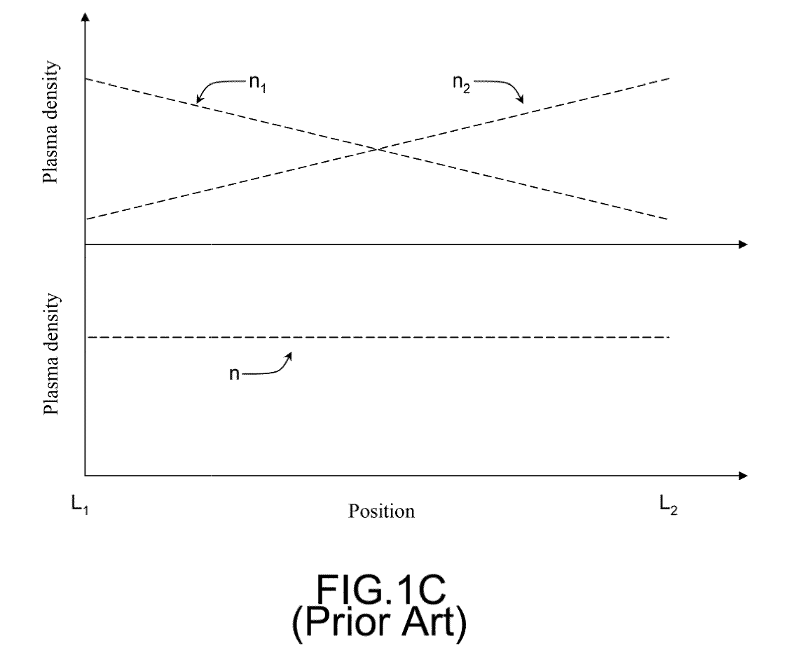

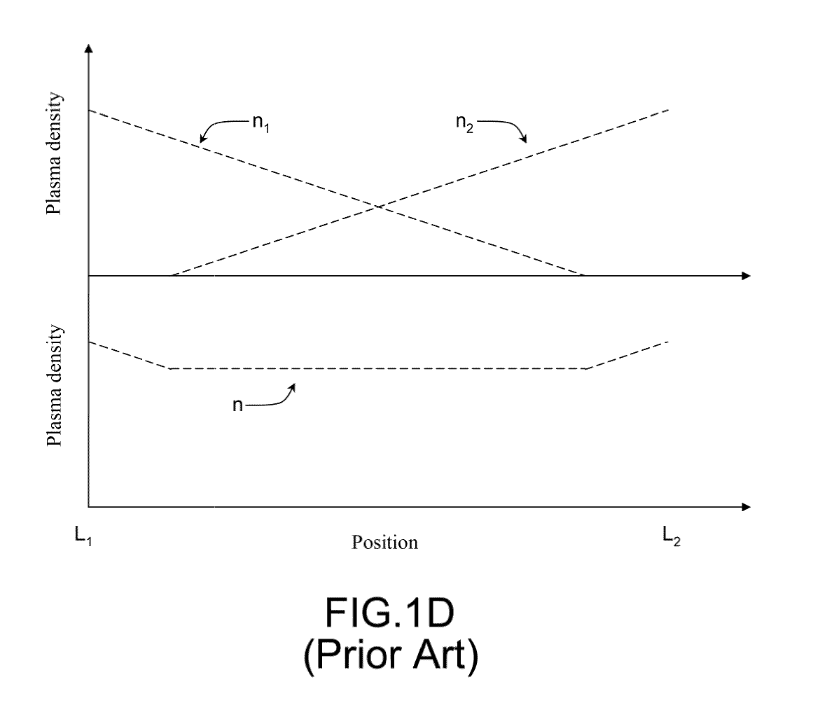

### DETAILED DESCRIPTION OF THE PREFERRED EMBODIMENT

The present invention can be exemplified by but not limited to the embodiments as described hereinafter.

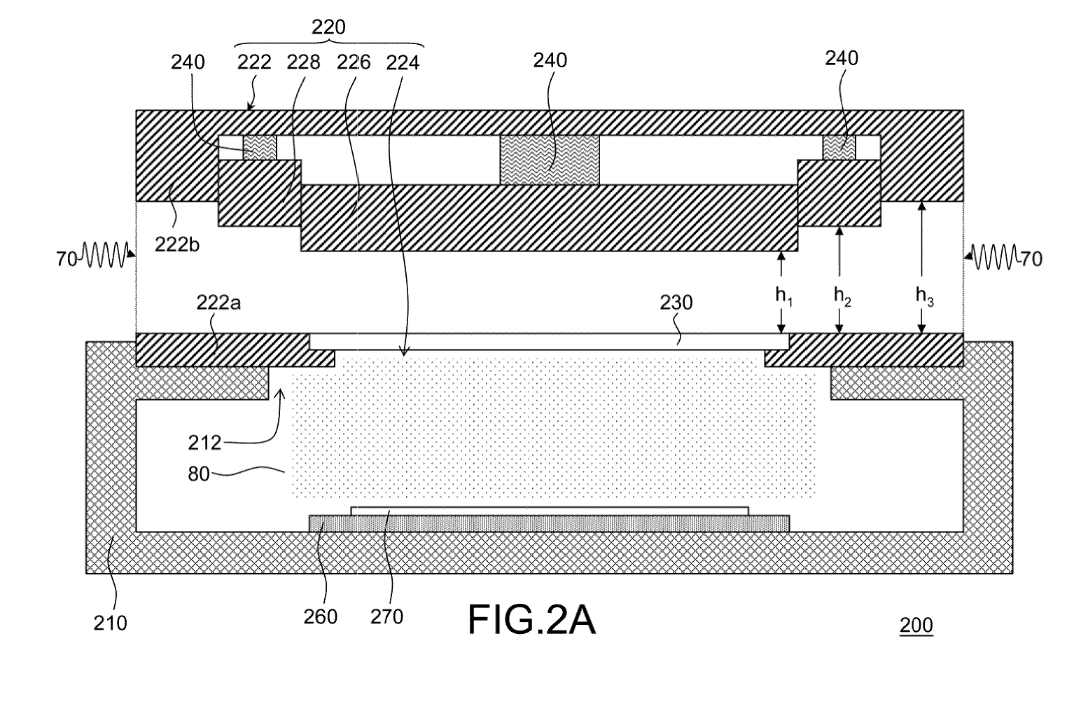

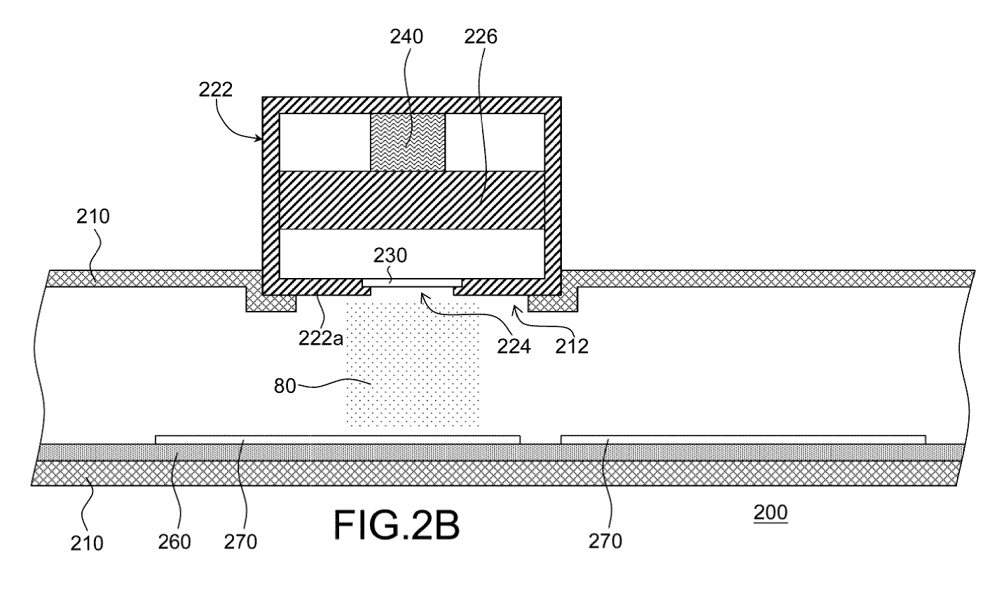

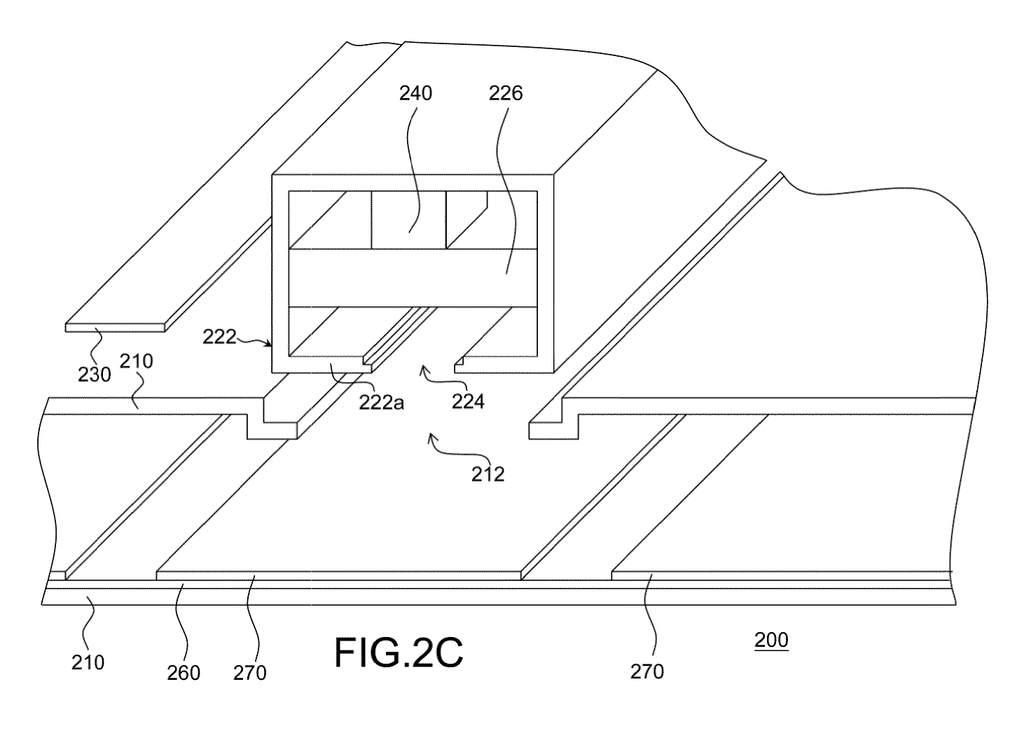

FIG. 2A is a cross-sectional view of a long linear-type microwave plasma source according to one embodiment of the present invention; FIG. 2B is a cross-sectional view of the long linear-type microwave plasma source in FIG. 2A; and FIG. 2C is a 3D exploded view of the long linear-type microwave plasma source in FIG. 2A. Please refer to FIG. 2A to FIG. 2C, wherein the long linear-type microwave plasma source 200 comprises a reaction chamber 210, a variably-reduced-height waveguide 220, a long linear-type coupling window 230 and a moving mechanism 240. The variably-reduced-height waveguide 220 is disposed on the reaction chamber 210. The variably-reduced-height waveguide 220 may be a rectangular waveguide. The variably-reduced-height waveguide 220 comprises a frame portion 222, a long linear-type coupling frame 224, a first moving portion 226 and two second moving portions 228. The frame portion 222 has a first wide side 222a adjacent to the reaction chamber 210. The long linear-type coupling frame 224 is disposed on the first wide side 222a of the frame portion 222. The first moving portion 226 and the two second moving portions 228 are disposed inside the frame portion 222, wherein the first moving portion 226 is disposed between the second moving portions 228. The long linear-type coupling window 230 is disposed on the long linear-type coupling frame 224. The moving mechanism 240 is capable of adjusting the distance h₁ between the first moving portion 226 and the first wide side 222a and the distance h₂ between the second moving portions 228 and the first wide side 222a .

Therefore, when the microwave power 70 is applied to the variably-reduced-height waveguide 220 at its two ends, the microwave power 70 travels inside the variably-reduced-height waveguide 220. According to the waveguide theory, the microwave power 70 leaks out of the variably-reduced-height waveguide 220 through the long linear-type coupling window 230 toward the reaction chamber 210 to excite plasma 80 and further perform film deposition on the substrate 250 that is carried by the conveyor belt 260.

Generally, the distance h₁ between the first moving portion 226 and the first wide side 222a (or referred to as the height of the waveguide) can be used to determine the leakage of the microwave power 70. In other words, the higher the height h₁ of the waveguide, the lower the leakage of the microwave power 70. The leakage of the microwave power 70 can be controlled by adjusting the distance h₁ so that the microwave power 70 input at any end of the waveguide 220 leaks into the reaction chamber before it reaches the other end without increasing the microwave power 70 to change the height of the waveguide 220. Therefore, uniform long linear-type plasma 80 can be generated.

Moreover, the leakage of the microwave power 70 depends on the pressure in the reaction chamber 21 and the width of the long linear-type coupling frame 224. Therefore, in the present invention, the moving mechanism 240 is capable of adjusting the height h₁ of the waveguide to achieve the optimal microwave leakage rate to generate uniform long linear-type plasma 80.

Moreover, the second moving portions 228 are used as a quarter wavelength impedance converter to achieve impedance matching. More particularly, the frame portion 222 has a second wide side 222b with respect to the first wide side 222a, wherein the distance h₃ between the second wide side 222b and first wide side 222a is a constant. In order to achieve optimal impedance matching, the moving mechanism 240 is capable of adjusting the distance h₂ according to the height h₁ of the waveguide, where h₂≅\sqrt{h₁×h₃}. Moreover, the moving mechanism 240 is, for example, made of automatical or manual devices to lift or lower the first moving portion 226 and the second moving portions 228. However, the present invention is not limited to the aforementioned example of the moving mechanism 240.

Referring to FIG. 2A to FIG. 2C, to achieve higher microwave leakage, the microwave power 70 is input into the variably-reduced-height waveguide 220 at one end to reach the other end. Ideally, when the microwave power 70 is input into the variably-reduced-height waveguide 220 at one end and leak out of the waveguide 220 completely as it reaches the other end, the excited plasma exhibits the highest efficiency with lowest power reflection. Therefore, if the reflected power of the microwave power 70 is too large, the moving mechanism 240 may shorten the distance h₁ between the first moving portion 226 and the first wide side 222a to increase the leakage of the microwave power 70 and shorten the distance h₂ between the second moving portions 228 and the first wide side 222a to achieve dual-port impedance matching. In other words, the moving mechanism 240 is capable of adjusting the distance h₁ between the first moving portion 226 and the first wide side 222a and the distance h₂ between the second moving portions 228 and the first wide side 222a according to the reflected microwave power.

In the present embodiment, the reaction chamber 210 is provided with a long linear-type coupling window 212. The variably-reduced-height waveguide 220 is disposed on the long linear-type coupling window 212 of the reaction chamber 210. The long linear-type coupling frame 224 is disposed corresponding to the long linear-type coupling window 212 with an O-ring at the top side to maintain a vacuum and two row of gas inlets at the bottom side to supply reaction gas for plasma. Moreover, the microwave plasma source 200 is also provided a conveyor belt 260 disposed inside the reaction chamber 210 under the long linear-type coupling frame 224. The conveyor belt 260 is capable of carrying a substrate 270 so that film deposition can be performed with the plasma 80 on the substrate 270. With an adjustable transport speed of the conveyor belt, the long linear-type plasma 80 provided in the present invention can be used to deposit uniform thin films on the substrate 270.

Therefore, there is an atmospheric pressure inside the variably-reduced-height waveguide 220. The pressure inside the reaction chamber 210 is lower. The long linear-type coupling window 230 separates the variably-reduced-height waveguide 220 and the reaction chamber 210. Beneath the long linear-type coupling frame 224, two rows of gas inlets (not shown) introduce reaction gases (not shown) into the reaction chamber 210 so that the reaction gases are excited by microwave to generate plasma 80 to deposit a thin film on the substrate 270.

Moreover, the long linear-type microwave plasma source 200 can be being used for continuous or batch type plasma processes. The variably-reduced-height waveguide 200 is capable of receiving the microwave power 70 at one end or two ends to excite plasma. Moreover, the long linear-type coupling window 230 may be made of quartz glass, ceramic or other dielectric materials.

It is noted that the generated plasma 80 is used for film deposition on the substrate 270. However, the plasma 80 in the present invention is not limited thereto. For example, plasma can also be used to etch the substrate. Moreover, the substrate 270 may be a silicon substrate or a transparent glass substrate. The long linear-type coupling window 230 may be made of quartz glass or other dielectric materials.

Accordingly, the microwave plasma reactor of the present invention controls the input microwave leakage by adjusting the distance between the first moving portion and the first wide side so as to enhance the length of the linear-type plasma without increasing the microwave power.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A long linear-type microwave plasma source, comprising:
a reaction chamber;
a variably-reduced-height waveguide, disposed on the reaction chamber, the variably-reduced-height waveguide comprising:
a frame portion with a first wide side adjacent to the reaction chamber;
a long linear-type coupling frame disposed on the first wide side of the frame portion;
a first moving portion disposed inside the frame portion; and
two second moving portions disposed inside the frame portion, the first moving portion being disposed between the second moving portions;
a long linear-type coupling window disposed on the long linear-type coupling frame; and
a moving mechanism capable of adjusting the distance between the first moving portion and the first wide side and the distance between the second moving portions and the first wide side.

2. The long linear-type microwave plasma source as recited in claim 1, wherein the long linear-type coupling frame is disposed at the center of the first wide side.

3. The long linear-type microwave plasma source as recited in claim 1, wherein the long linear-type coupling frame is disposed away from the center of the first wide side.

4. The long linear-type microwave plasma source as recited in claim 1, wherein the width of the long linear-type coupling frame is smaller than or equal to the width of the first wide side the frame portion.

5. The long linear-type microwave plasma source as recited in claim 1, wherein the microwave is input at two ends of the variably-reduced-height waveguide, while the moving mechanism adjusts the distance between the first moving portion and the first wide side and the distance between the second moving portions and the first wide side according to reflected microwave power intensity at the two ends of the variably-reduced-height waveguide.

6. The long linear-type microwave plasma source as recited in claim 1, further comprising a sealing O-ring disposed between the long linear-type coupling window and the long linear-type coupling frame to maintain a vacuum.

7. The long linear-type microwave plasma source as recited in claim 1, wherein the long linear-type coupling frame is provided with two rows of gas inlets at a bottom side so as to supply reaction gas for plasma.

8. The long linear-type microwave plasma source as recited in claim 1, wherein the long linear-type coupling window is made of quartz glass, ceramic or dielectric.

9. The long linear-type microwave plasma source as recited in claim 1, wherein the variably-reduced-height waveguide is capable of receiving microwave power and transmitting the microwave power to the reaction chamber through the long linear-type coupling window to excite plasma.

10. The long linear-type microwave plasma source as recited in claim 1, wherein the variably-reduced-height waveguide is capable of receiving microwave power at one end or two ends to excite plasma.

11. The long linear-type microwave plasma source as recited in claim 1, being used for continuous or batch type plasma processes.

12. The long linear-type microwave plasma source as recited in claim 1, wherein the variably-reduced-height waveguide is rectangular.
